(19) United States
(12) Patent Application Publication
(10) Pub. No.: US 2022/0303833 A1
(43) Pub. Date: Sep. 22, 2022

(54) RELATION INDICATION FOR MULTI-SIM DEVICES

(71) Applicant: Telefonaktiebolaget LM Ericsson (publ), Stockholm (SE)

(72) Inventors: Mattias Bergström, Sollentuna (SE); Magnus Stattin, Upplands Väsby (SE); Paul Schliwa-Bertling, Ljungsbro (SE)

(21) Appl. No.: 17/638,924

(22) PCT Filed: Aug. 25, 2020
(86) PCT No.: PCT/IB2020/057940

§ 371 Date: Feb. 28, 2022

Related U.S. Application Data
(60) Provisional application No. 62/893,608, filed on Aug. 29, 2019.

(51) Int. Cl. H04W 36/00; H04W 36/08

(52) U.S. Cl. CPC H04W 36/0009; H04W 36/00837; H04W 36/0038; H04W 36/08

(57) ABSTRACT

A method for indicating and operating multiple User Equipment (UEs) in a wireless device is provided. In embodiments disclosed herein, the wireless device can recognize that there exist multiple UEs in the wireless device and determine a relation between the multiple UEs in the wireless device. Accordingly, the wireless device can provide an indication to a network node (e.g., a base station) to indicate the determined relation between the multiple UEs. The network node, one the other hand, can cause the wireless device to perform one or more actions (e.g., paging, handover, etc.) based on the indicated relation between the multiple UEs in the wireless device. By being able to determine and indicate the multiple UEs in the wireless device and perform network operations accordingly, it is possible to enhance convenience, flexibility, mobility, and basic economics of the wireless device, thus helping to improve subscriber experience.

### RELATED APPLICATIONS

This application claims the benefit of provisional patent application Ser. No. 62/893,608, filed Aug. 29, 2019, the disclosure of which is hereby incorporated herein by reference in its entirety.

### TECHNICAL FIELD

The technology of the disclosure relates generally to operations of a wireless device having multiple Subscriber Identity Modules (SIMs) (multi-SIM) in a wireless communications network.

### BACKGROUND

A Subscriber Identity Module (SIM) card is an integrated circuit that is designed to securely store information, such as International Mobile Subscriber Identity (IMSI) and International Mobile Equipment Identity (IMEI), for identifying and authenticating a subscriber in a wireless communications network, such as a Long-Term Evolution (LTE) network. In this regard, a wireless device (e.g., smartphone) needs to include at least one SIM card to be operational in a wireless communications network.

Nowadays, it becomes increasingly popular for a wireless device to include more than one SIM card. Accordingly, such a wireless device is conveniently referred to as a multi-SIM device. Notably, each SIM card is typically associated with a unique phone number. As such, a multi-SIM device may provide greater flexibility for partitioning data, voice, text, and multimedia services across multiple phone numbers. For example, a wireless device with two SIM cards can be configured to have one phone number dedicated for business usage and another phone number dedicated for personal usage.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### SUMMARY

Embodiments disclosed herein include a method for indicating and operating multiple User Equipment (UEs) in a wireless device. In a non-limiting example, each of the multiple UEs corresponds to a respective Subscriber Identity Module (SIM) card. In this regard, the wireless device is also referred to a multi-SIM device. In embodiments disclosed herein, the wireless device can recognize that there exist multiple UEs in the wireless device and determine a relation between the multiple UEs in the wireless device. Accordingly, the wireless device can provide an indication to a network node (e.g., a base station) to indicate the determined relation between the multiple UEs. The network node, one the other hand, can cause the wireless device to perform one or more actions (e.g., paging, handover, etc.) based on the indicated relation between the multiple UEs in the wireless device. By being able to determine and indicate the multiple UEs in the wireless device and perform network operations accordingly, it is possible to enhance convenience, flexibility, mobility, and basic economics of the wireless device, thus helping to improve subscriber experience.

In one embodiment, a method performed by a wireless device for indicating and operating multiple UEs is provided. The method includes sending an indication to a network node to indicate a relation between a first UE and a second UE, wherein the first UE and the second UE are both comprised in the wireless device. The method also includes performing one or more actions based on the indicated relation.

In another embodiment, the method also includes detecting a triggering event for indicating the relation between the first UE and the second UE prior to sending the indication to the network node.

In another embodiment, the triggering event comprises one or more of: reception of a request from the network node; activation of a new Subscriber Identification Module (SIM) in the wireless device; establishment of a network connection by the wireless device; and performance of a network access procedure by the wireless device.

In another embodiment, sending the indication comprises sending, from the first UE to the network node or from the second UE to the network node, a UE capability information comprising the indication that the first UE is associated with the second UE.

In another embodiment, sending the indication comprises sending the indication during a Radio Resource Control (RRC) connection establishment procedure.

In another embodiment, sending the indication comprises securing the indication by means of one or more of: encrypting the indication; sending the indication after enabling security with the network node; and sending the indication in a message for enabling the security with the network node.

In another embodiment, performing one or more actions based on the indicated relation comprises, at the first UE: receiving a paging message in a cell of the second UE; and performing a random access procedure in response to receiving the paging message.

In another embodiment, the cell of the second UE is a Primary Cell (PCell) of the second UE.

In another embodiment, performing one or more actions comprises, at the second UE: receiving an indication from the network node to wake up the first UE; and triggering the first UE to wake up upon receiving the indication to wake up the first UE.

In another embodiment, performing one or more actions further comprises performing one or more actions at the first UE to wake up.

In another embodiment, performing one or more actions comprises, at the first UE: receiving a handover indication from the network node to hand over to a particular cell; and applying the handover indication to both the first UE and the second UE such that the first UE and the second UE both hand over to the particular cell.

In another embodiment, performing one or more actions comprises receiving, at the first UE, a second indication that indicates whether the handover indication is applicable to the second UE.

In another embodiment, performing one or more actions comprises performing a procedure whereby the first UE and the second UE select a same cell to camp on.

In another embodiment, performing the procedure comprises, at the first UE: obtaining information about the second UE; and performing cell selection based on the information about the second UE.

In another embodiment, performing one or more actions comprises, at the first UE: performing a measurement at the first UE; and sharing the measurement with the second UE.

In one embodiment, a method performed by a network node for a cellular communications system is provided. The method includes receiving an indication that indicates a relation between a first UE and a second UE both comprised in a wireless device. The method also includes performing one or more actions based on the indicated relation.

In another embodiment, performing one or more actions comprises providing the indication to another network node.

In another embodiment, performing one or more actions comprises sending a paging message to the first UE in a cell of the second UE.

In another embodiment, performing one or more actions comprises sending an indication to the second UE to wake up the first UE.

In another embodiment, performing one or more actions comprises: indicating scheduled resources for the first UE; and indicating scheduled resources for the second UE, wherein the scheduled resources for the first UE are different from the scheduled resources for the second UE.

In another embodiment, performing one or more actions comprises refraining from scheduling the second UE when the first UE is paged.

In another embodiment, performing one or more actions comprises at least one of: refraining from assigning to the first UE scheduled resources that collide with scheduled resources assigned to the second UE; and refraining from assigning to the second UE scheduled resources that collide with scheduled resources assigned to the first UE.

In another embodiment, performing one or more actions comprises at least one of: providing a handover indication to the first UE to hand over to a particular cell; and providing a second indication that indicates whether the handover indication is applicable to the second UE.

In another embodiment, receiving an indication comprises receiving the indication from the first UE, the second UE, or a combination thereof.

In another embodiment, receiving an indication comprises one or more of: receiving, from the first UE, a UE capability information comprising the indication that the first UE is associated with the second UE; receiving the indication during a Radio Resource Control (RRC) connection establishment procedure; and receiving the indication in a message for enabling security with the network node.

In another embodiment, the indication comprises an identity of the second UE.

In another embodiment, the identity of the second UE comprises one of: a Cell Radio Network Temporary Identifier (C-RNTI); a Serving Temporary Mobile Subscriber Identity (S-TMSI); an Inactive Radio Network Temporary Identifier (I-RNTI); a Resume Identification; a Global Unique Temporary Identifier (GUTI); and a new identity for indicating an association between the second UE and other UEs.

In another embodiment, receiving an indication comprises receiving the indication from the second UE that indicates the relation between the first UE and the second UE.

In another embodiment, the indication comprises an identity of the first UE.

In another embodiment, the identity of the first UE comprises one of: a C-RNTI; a S-TMSI; an I-RNTI; a Resume Identification; a GUTI; and a new identity for indicating an association between the second UE and other UEs.

In another embodiment, receiving an indication comprises receiving the indication that indicates the relation between the first UE and the second UE from another network node.

In one embodiment, a wireless device is provided. The wireless device includes processing circuitry configured to perform any of the steps performed by the UE in any of the claims performed by the wireless device. The wireless device also includes power supply circuitry configured to supply power to the wireless device.

In one embodiment, a network node is provided. The network node includes a control system configured to perform any of the steps performed by the network node in any of the claims performed by the network node.

In one embodiment, a method performed by a core network node for enabling a wireless device to indicate and operate multiple UEs is provided. The method includes providing, to a network node, an indication that a first UE and a second UE in the wireless device are associated.

In another embodiment, the method also includes obtaining information indicating that the first UE and the second UE are associated from at least one of a Unified Data Management (UDM) and an Access and Mobility Management Function (AMF).

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 illustrates a wireless communication system represented as a Fifth Generation (5G) network architecture composed of core Network Functions (NFs), where interaction between any two NFs is represented by a point-to-point reference point/interface;

FIG. 3 illustrates a 5G network architecture using service-based interfaces between the NFs in the control plane, instead of the point-to-point reference points/interfaces used in the 5G network architecture of FIG. 2;

FIG. 4 is a schematic diagram of an exemplary wireless communications network in which a wireless device and a network node can be configured according to embodiments of the present disclosure to identify and operate multiple Subscriber Equipment (UEs) in the wireless device;

FIG. 5 is a flowchart illustrating a method performed by the wireless device in FIG. 4 for identifying and operating multiple UEs in the wireless device;

FIG. 6A is a flowchart illustrating a method performed by the network node in FIG. 4 for enabling the wireless device to identify and operate the multiple UEs;

FIG. 6B is a flowchart illustrating a method performed by a Core Network (CN) for enabling the wireless device to identify and operate the multiple UEs;

FIG. 7 is a signal flow diagram illustrating exemplary signaling between the wireless device and the network node in FIG. 4 according to an embodiment of the present disclosure;

FIG. 8 is a signal flow diagram illustrating exemplary signaling between the wireless device and the network node in FIG. 4 according to another embodiment of the present disclosure;

FIG. 9 is a signal flow diagram illustrating exemplary signaling between the wireless device and the network node in FIG. 4 according to another embodiment of the present disclosure;

FIG. 10 is a signal flow diagram illustrating exemplary signaling between the wireless device and the network node in FIG. 4 according to another embodiment of the present disclosure;

FIG. 11 is a signal flow diagram illustrating exemplary signaling between the wireless device and the network node in FIG. 4 according to another embodiment of the present disclosure;

FIG. 12 is a signal flow diagram illustrating exemplary signaling between the wireless device and the network node in FIG. 4 according to another embodiment of the present disclosure;

FIG. 13 is a signal flow diagram illustrating exemplary signaling between the wireless device and the network node in FIG. 4 according to another embodiment of the present disclosure;

FIG. 14 is a signal flow diagram illustrating exemplary signaling between the wireless device and the network node in FIG. 4 according to another embodiment of the present disclosure;

FIG. 15 is a signal flow diagram illustrating exemplary signaling between the wireless device and the network node in FIG. 4 according to another embodiment of the present disclosure;

FIG. 16 is a signal flow diagram illustrating exemplary signaling between the wireless device and the network node in FIG. 4 according to another embodiment of the present disclosure;

FIG. 17 is a schematic block diagram of a network node according to some embodiments of the present disclosure;

FIG. 18 is a schematic block diagram that illustrates a virtualized embodiment of the network node according to some embodiments of the present disclosure;

FIG. 19 is a schematic block diagram of the network node of FIG. 17 according to some other embodiments of the present disclosure;

FIG. 20 is a schematic block diagram of a UE according to some embodiments of the present disclosure;

FIG. 21 is a schematic block diagram of the UE of FIG. 20 according to some other embodiments of the present disclosure;

FIG. 22 is a communication system according an embodiment of the present disclosure;

FIG. 23 is a communication system according an embodiment of the present disclosure;

FIG. 24 is a flowchart illustrating a method implemented in a communication system, in accordance with one embodiment of the present disclosure;

FIG. 25 is a flowchart illustrating a method implemented in a communication system, in accordance with one embodiment of the present disclosure;

FIG. 26 is a flowchart illustrating a method implemented in a communication system, in accordance with one embodiment of the present disclosure; and

FIG. 27 is a flowchart illustrating a method implemented in a communication system, in accordance with one embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network or any node that implements a core network function. Some examples of a core network node include, e.g., a Mobility Management Entity (MME), a Packet Data Network Gateway (PGW), a Service Capability Exposure Function (SCEF), a Home Subscriber Server (HSS), or the like. Some other examples of a core network node include a node implementing a Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

It will herein be described methods for multi-SIM devices. In some descriptions, it may be described a dual-SIM UE, i.e. a UE having two SIMs, however the embodiments can be applied for devices with more than two SIMs.

It should be noted that it will herein be described how a device which has multiple SIMs can be seen as the device is hosting multiple UEs. From a network point of view, the device may be seen as multiple UEs—one per SIM.

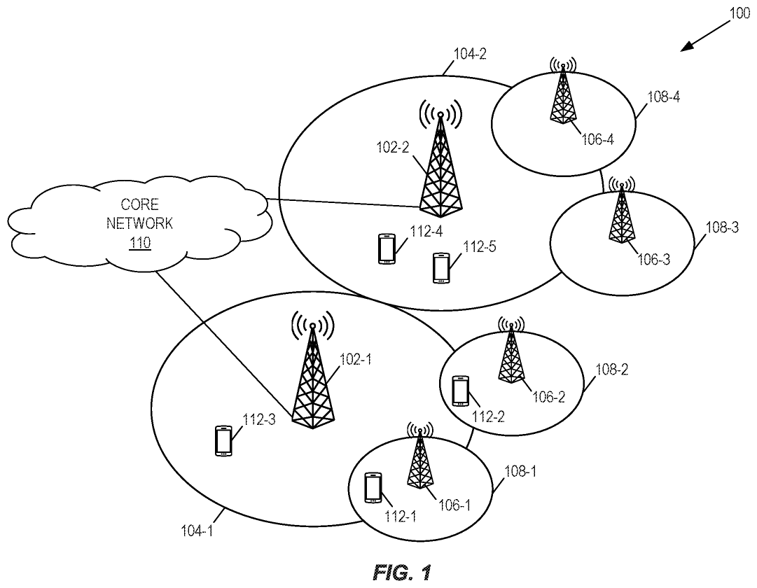

In this regard, FIG. 1 illustrates one example of a cellular communications system 100 in which embodiments of the present disclosure may be implemented. In the embodiments described herein, the cellular communications system 100 is a 5G system (5GS) including a NR Random Access Network (RAN) or LTE RAN (i.e., E-UTRA RAN) or an Evolved Packet System (EPS) including a LTE RAN. In this example, the RAN includes base stations 102-1 and 102-2, which in LTE are referred to as eNBs (when connected to Evolved Packet Core (EPC)) and in 5G NR are referred to as gNBs (e.g., LTE RAN nodes connected to 5GC, which are referred to as eNBs), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5GS is referred to as the 5G core (5GC). The base stations 102 (and optionally the low power nodes 106) are connected to the core network 110.

The base stations 102 and the low power nodes 106 provide service to wireless devices 112-1 through 112-5 in the corresponding cells 104 and 108. The wireless devices 112-1 through 112-5 are generally referred to herein collectively as wireless devices 112 and individually as wireless device 112. The wireless devices 112 are also sometimes referred to herein as UEs.

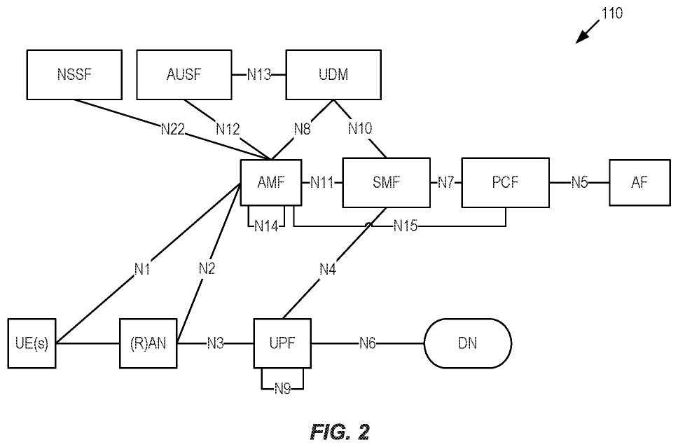

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the system 100 of FIG. 1.

Seen from the access side the 5G network architecture shown in FIG. 2 comprises a plurality of UEs connected to a RAN or an Access Network (AN) as well as an AMF. Typically, the (R)AN comprises base stations, e.g. such as eNBs or gNBs or similar. Seen from the core network side, the 5G core NFs shown in FIG. 2 include a NSSF, an AUSF, a UDM, an AMF, a SMF, a PCF, and an AF.

Reference point representations of the 5G network architecture are used to develop detailed call flows in the normative standardization. The N1 reference point is defined to carry signaling between the UE and AMF. The reference points for connecting between the AN and AMF and between the AN and UPF are defined as N2 and N3, respectively. There is a reference point, N11, between the AMF and SMF, which implies that the SMF is at least partly controlled by the AMF. N4 is used by the SMF and UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since the PCF applies policy to the AMF and SMP, respectively. N12 is required for the AMF to perform authentication of the UE. N8 and N10 are defined because the subscription data of the UE is required for the AMF and SMF.

The 5G core network aims at separating user plane and control plane. The user plane carries user traffic while the control plane carries signaling in the network. In FIG. 2, the UPF is in the user plane and all other NFs, i.e., the AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like the PCF and AUSF can be separated as shown in FIG. 2. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

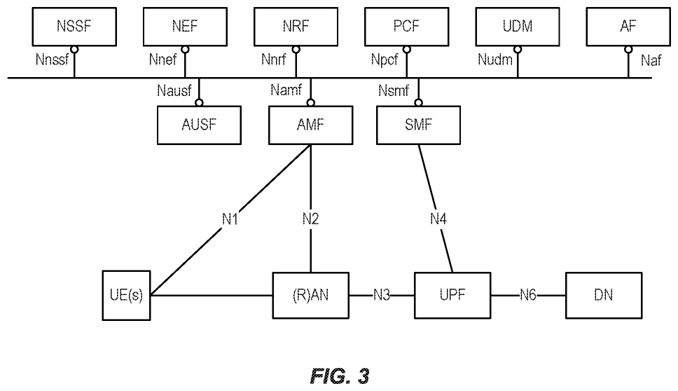

FIG. 3 illustrates a 5G network architecture using service-based interfaces between the NFs in the control plane, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF and Nsmf for the service based interface of the SMF etc. The NEF and the NF NRF in FIG. 3 are not shown in FIG. 2 discussed above. However, it should be clarified that all NFs depicted in FIG. 2 can interact with the NEF and the NRF of FIG. 3 as necessary, though not explicitly indicated in FIG. 2.

Some properties of the NFs shown in FIGS. 2 and 3 may be described in the following manner. The AMF provides UE-based authentication, authorization, mobility management, etc. A UE even using multiple access technologies is basically connected to a single AMF because the AMF is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF provides information on the packet flow to the PCF responsible for policy control in order to support Quality of Service (QoS). Based on the information, the PCF determines policies about mobility and session management to make the AMF and SMF operate properly. The AUSF supports authentication function for UEs or similar and thus stores data for authentication of UEs or similar while the UDM stores subscription data of the UE. The Data Network (DN), not part of the 5G core network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

Embodiments disclosed herein include a method for indicating and operating multiple UEs in a wireless device. In a non-limiting example, each of the multiple UEs corresponds to a respective SIM card. In this regard, the wireless device is also referred to as a multi-SIM device. In embodiments disclosed herein, the wireless device can recognize that there exist multiple UEs in the wireless device and determine a relation between the multiple UEs in the wireless device. Accordingly, the wireless device can provide an indication to a network node (e.g., a base station) to indicate the determined relation between the multiple UEs. The network node, on the other hand, can cause the wireless device to perform one or more actions (e.g., paging, handover, etc.) based on the indicated relation between the multiple UEs in the wireless device. By being able to determine and indicate the multiple UEs in the wireless device and perform network operations accordingly, it is possible to enhance convenience, flexibility, mobility, and basic economics of the wireless device, thus helping to improve subscriber experience.

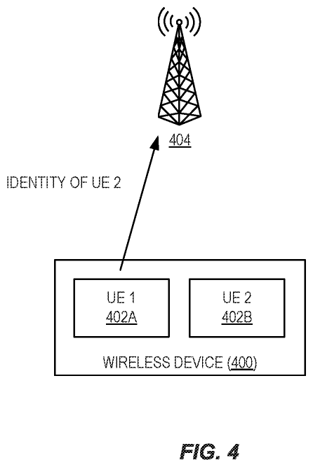

Now, a description of some example embodiments of the present disclosure is provided. In this regard, FIG. 4 is a schematic diagram of an exemplary wireless communications network in which a wireless device 400, which includes a first UE 402A and a second UE 402B, and a network node 404 can be configured according to embodiments of the present disclosure to identify and operate multiple UEs 402A and 402B in the wireless device 400.

In one embodiment, a wireless device (e.g., a wireless device 112) indicates to a network node (e.g., base station 106) (referred to interchangeably as “network”) that there is a relation of a first UE (referred to herein as UE 1) in the wireless device and a second UE in the wireless device (referred herein to as UE 2). This indication may be an indication of an identity of the second UE, which the first UE indicates, as illustrated in FIG. 4.

In some versions of this embodiment, it may be so that UE 1 indicates a relation to UE 2, and that UE 2 indicates a relation to UE 1.

The indication which UE 1 indicates may be an identity associated with UE 2. Alternatively, the indication is an identity associated with both UEs, i.e. UE 1 and UE 2 have an identity which is associated to both UEs.

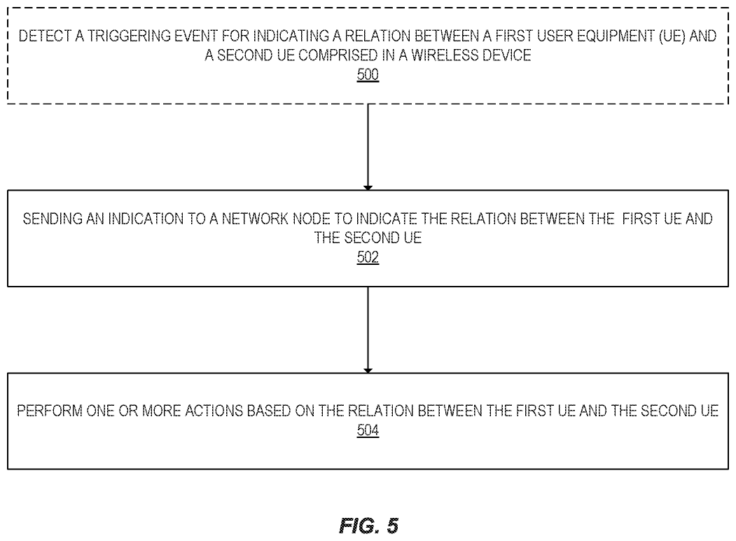

FIG. 5 is a flowchart illustrating a method performed by the wireless device 400 in FIG. 4 for identifying and operating the multiple UEs 402A and 402B in the wireless device 400. In this regard, the wireless device 400 may detect a triggering event for indicating a relation between the first UE 402A and the second UE 402B, which are both provided inside the wireless device 400 (block 500). The wireless device 400 sends an indication to the network node 404 to indicate the relation between the first UE 402A and the second UE 402B (block 502). Subsequently, the wireless device 400 performs one or more actions (e.g., multi-SIM actions) based on the relation between the first UE 402A and the second UE 402B (block 504).

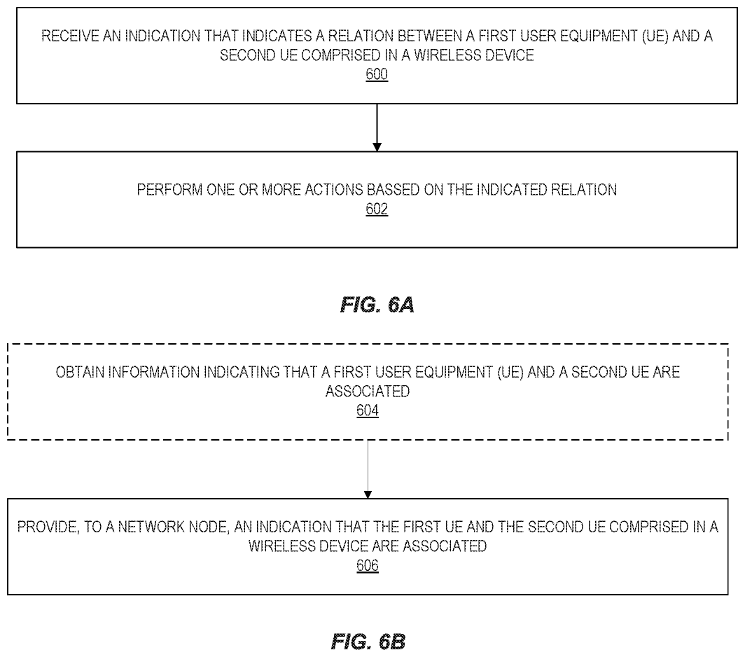

FIG. 6A is a flowchart illustrating a method performed by the network node 404 in FIG. 4 for enabling the wireless device 400 to identify and operate based on the multiple UEs 402A and 402B. In this regard, the network node 404 receives the indication from the wireless device 400 that indicates the relation between the first UE 402A and the second UE 402B in the wireless device 400 (block 600). The network node 404 then performs one or more actions based on the indicated relation (block 602).

FIG. 6B is a flowchart illustrating a method performed by a Core Network (CN), such as the core network 110, for enabling the wireless device 400 to identify and operate the multiple UEs 402A and 402B. In this regard, the CN can provide to the network node 404 an indication that the first UE 402A and the second UE 402B in the wireless device 400 are associated (block 604).

The wireless device 400 may report the relation indication in one or more of the following ways.

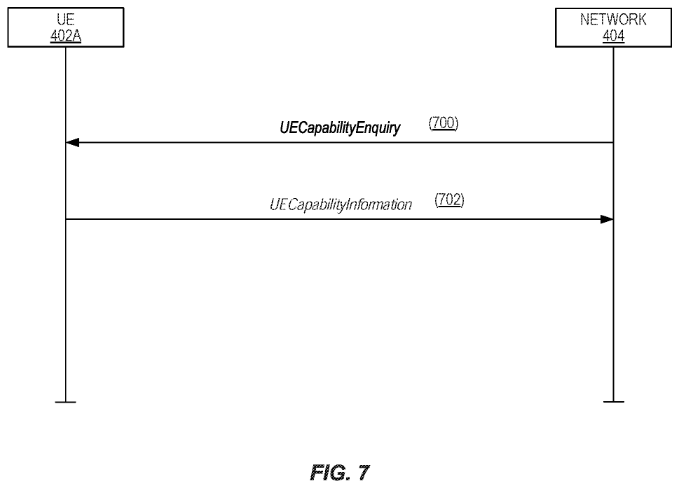

In one non-limiting example, as illustrated in FIG. 7, a UE may indicate the relation indication together with, or within, UE capabilities. This may be a new field within a UECapabilityInformation message (e.g., step 702).

In another non-limiting example, the UE may indicate the relation indication in a message which is sent in response to a request sent from the network (e.g., step 700).

The network may configure the UE to send the relation indication to the network based on some triggers. For example, the trigger for the message may not be an explicit request from the network, but rather that the network indicates that the UE should send a message, which can carry the relation indication and the UE may do so in response to certain triggers.

One example trigger may be that a UE in the wireless device triggered certain actions, for example, established a connection to the network (a “connection” may for example be a connection on core network/NAS (Non-Access Stratum) level, or a connection to a radio access network/AS (Access Stratum) level.

Another example is that the UE can send an update in response to a new SIM being activated in the device. This has the benefit that the UE does not send the indication unless there actually are two SIMs in the device.

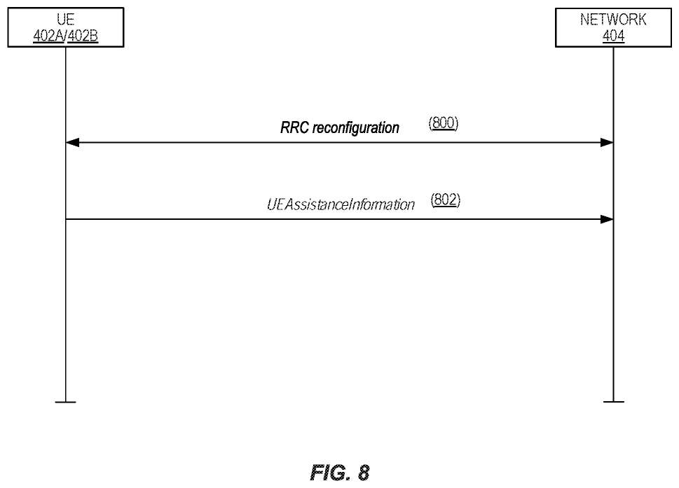

As illustrated in FIG. 8, the network may, in an RRC reconfiguration message 800, indicate that the UE should send the relation information in a UEAssistanceInformation message 802 and the UE would do so in response to certain triggers.

The UE may send the relation indication during a procedure used by the UE to access the network. This may for example be during an RRC connection establishment procedure, an RRC connection resume procedure, an RRC connection re-establishment procedure, etc.

The relation indication may for example be sent in a message used to complete the above procedures (RRCSetupComplete, RRCResumeComplete, RRCReestablishmentComplete), or in a message used to request the above procedures (RRCSetupRequest, RRCResumeRequest, RRCReestablishmentRequest).

Whether or not the UE should include such information in a message related to the access procedure may be indicated by the network in a message (e.g., RRCSetup) for example by a flag indicating that the network requests such information.

Notably, the relation information may be considered sensitive information and hence may only be sent after the connection has been secured (e.g., encryption has been enabled).

For approaches where the network requests the UE to send the relation indication, the network may request such information only after security has been enabled.

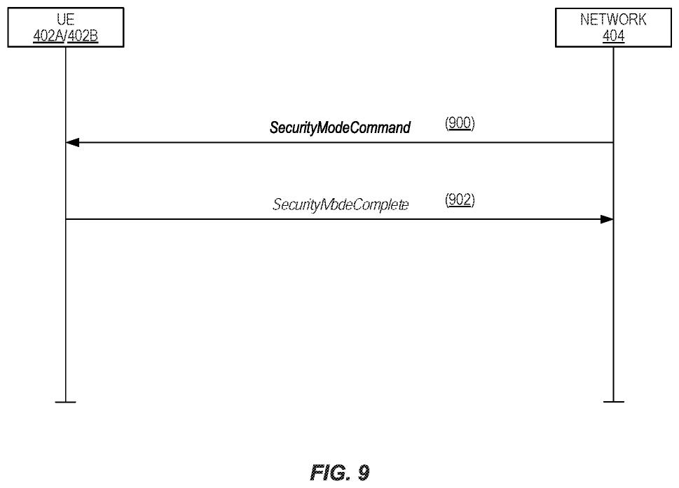

Another approach is that the information is requested during the procedure for enabling security, for example in the SecurityModeCommand message. As illustrated in FIG. 9, the UE may receive a SecurityModeCommand message 900 from the network node 404. The UE responds with the relation indication together with a SecurityModeComplete message 902 or in another message in response to the SecurityModeCommand message 900.

During mobility in an RRC_CONNECTED state, the source RAN node includes the relation indication in the handover preparation procedure and includes it in the relevant source RAN to target RAN message (e.g., NGAP HANDOVER REQUIRED or XnAP HANDOVER REQUEST message). The relation indication may be included in the source RAN to target a RAN transparent container.

In one embodiment, a core network node may indicate a relation between two UEs. In this regard, the CN (e.g., the AMF) includes in the relevant procedures the relation indication to the RAN. In one example, such procedure is New Generation Application Protocol (NGAP) Initial Context Setup procedure for the first UE where AMF includes the relation indication to the second UE in the NGAP INITIAL UE CONTEXT SETUP REQUEST message sent from the AMF to RAN. Another example procedure is NGAP Downlink Non-Access Stratum (NAS) Transport procedure to the first UE where the AMF includes the relation indication to the second UE in NGAP DOWNLINK NAS TRANSPORT message sent to RAN when a NAS message (e.g., Registration Accept) is sent to the first UE in the registration procedure.

The CN node assigning the relation indication (e.g., the AMF) may be made aware of the relation between two or multiple UEs in the same wireless device 400 (e.g., by means of subscription information available in a database, for example, UDM) and provided to the AMF during initial registration/registration procedure of one of the UEs in the wireless device 400 or later on, when changes to the subscription information occur.

The subscription data stored in the UDM may contain information indicating that multiple UEs exist in a single wireless device (e.g., the subscription information may contain multiple related identities, for example, Subscription Permanent Identifiers (SUPIs) listed). At registration of one of the UEs and thus the associated identity to the network (e.g., at Initial Registration procedure), the AMF may be provided by the UDM with a list of all or a subset of identities associated with that subscription and thus other UEs within the same wireless device.

If the second UE on that wireless device is already registered in the network, the AMF (e.g., at registration of the first UE may receive indication from the UDM which identity that second, already registered UE is associated with. The AMF uses that identity as a key to determine the relation indication (e.g., the 5G S-TMSI) that the second, already registered UE is assigned. The AMF includes the relation indication already assigned by the CN (e.g., AMF) to the second UE in the relevant message sent from the CN (e.g., AMF to RAN) in relevant procedures related to the first UE.

If the second UE registers with the network subsequent to the first UE, then the data base (e.g., the UDM) may update the AMF managing the first registered UE providing the identity of the second UE. The AMF uses that identity as a key to determine the relation indication (e.g., the 5G S-TMSI) that the second, already registered UE is assigned. In this case the AMF may update the RAN using (e.g., the NGAP UE Context Modification procedure the first UE Context in RAN) with the relation indication of the second UE.

If the second UE is already registered in the network but in a second AMF that is different than the first AMF that the first UE is currently registered with, then the UDM may include, in addition to the identity of the second UE (e.g., SUPI), the identifier indicating the identity of the second AMF (e.g., second AMF's Globally Unique AMF Identification (GUAMI)) to the first AMF (e.g., in the procedure providing the update of the subscription information to the first AMF). The first AMF may use the identity of the second AMF to retrieve information from the second AMF about the relation indication using a new procedure/service on the interface between the relevant CN nodes (e.g., on the N14 reference point/interface between the first and the second AMF). In this case the first AMF may update the RAN with the relation indication using (e.g., the NGAP UE Context Modification procedure updating the first UE Context in RAN).

In another embodiment, the second UE may include in NAS signaling the relation indication of the first UE, for example, indication to the network that first UE in the wireless device is registered to the network. This relation indication may be included, for example, in any initial NAS message (Registration Request or Service Request). In the case that this information is considered to be provided in a secure manner and no NAS security context is yet available in the second UE, the relation indication may be provided after NAS security has been enabled in the UE (e.g., in the Security Mode Complete message). The relation indication can be (e.g., the second UE's 5G Global Unique Temporary Identifier (GUTI)). In this embodiment the relation indication may be used addressing a scenario where the UEs' subscriptions are associated with different operators not sharing a common data base, (e.g., UDM).

To enable transfer of the relation indication of UEs that have subscription with different operators, the UEs may be configured and authorized by the network to:
Share the relation indication between the protocol entities communicating with its respective network entities operated by respective operators;
Stop sharing the relation indication between the protocol entities.

The CN (e.g., the AMF), in which the second AMF registers, stores the relation indication indicating relation to the first UE in second UE. Subsequently, the AMF provides the relation information to the RAN that manages the second UE where it may be stored in the second UE's context.

As examples, the relation information can be provided from CN (e.g., AMF) to RAN in the UE's associated procedures (see 3GPP TS 38.413v15.3.0) related to:
UE Context management in RAN (e.g., Initial UE Context Setup);
Transport of NAS messages; and
UE mobility management procedures.

In some embodiments, it is assumed that both UEs are in the same AMF. Further, in some embodiments, S-TMSI for one UE is established when the other UE connects.

In some embodiments, AMF indicates to RAN for first UE changing state that there is second UE which is related to the first UE (e.g., S-TMSI).

In some embodiments, if UEs are in different AMFs, there could be an indication from AMF 1 to AMF2.

In some embodiments, the indication of the associated UEs is sent from CN, for example, if a CN-type of id, S-TMSI is used.

In some embodiments, the indication of the associated UEs is sent by UE to AMF via NAS signaling and then to RAN.

In a non-limiting example, the first UE 402A can be linked to the second UE 402B based on one or more different identities.

In one example, the first UE 402A can be linked to the second UE 402B based on Cell Radio Network Temporary Identifier (C-RNTI). In this regard, UE 1 indicates the C-RNTI of UE 2. Notably, this may only work when both UEs are in CONNECTED mode since C-RNTI is an identity that may not be kept by a UE when the UE exists in CONNECTED mode.

Another candidate indication which can be used to indicate a relation between UE is a C-RNTI. It may be so that UE 1 indicates the S-TMSI of UE 2. This has the benefit that the S-TMSI is an identifier which is not released when a UE exits CONNECTED mode. This identity can then work also for UEs in IDLE mode.

In another example, the first UE 402A can be linked to the second UE 402B based on Inactive Radio Network Temporary Identifier (I-RNTI).

In this regard, another candidate indication which can be used to indicate a relation between UEs is an I-RNTI. It may be so that UE 1 indicates the I-RNTI of UE 2. The I-RNTI is an identity which a UE is assigned for use when the UE is in RRC_INACTIVE and is used by the UE when returning to CONNECTED mode and then indicated to the RAN so that RAN can identify the UE (e.g., so that the RAN can retrieve the context of the UE).

In another example, the first UE 402A can be linked to the second UE 402B based on Resume ID. The Resume ID is given to a UE for use when the UE is in IDLE mode and when the UE returns to CONNECTED mode the UE indicates the Resume ID to the RAN so that the RAN can retrieve the UE's context.

In another example, the first UE 402A can be linked to the second UE 402B based on GUTI.

In this regard, another candidate indication which can be used to indicate a relation between UE is a GUTI. It may be so that UE 1 indicates the GUTI of UE 2. This has the benefit that the GUTI is an identifier that is not released when a UE exits CONNECTED mode. This identity can then work also for UEs in IDLE mode. Furthermore, this identifier enables identification across the PLMNs and CN entities.

In another example, the first UE 402A can be linked to the second UE 402B based on a new identity, which may be generated by the wireless device 400 and indicated to the network by both UE 1 and UE 2. In this regard, if the network detects two UEs indicating the same identity, the network knows that these UEs are related. This has the benefit that the identity may not need to change regardless of the status of UE 1 and UE 2.

Below a set of embodiments that relate to different uses of the knowledge of the relations between UEs are described. These embodiments may be used separately or any two or more of them may be used together

In one embodiment, a network node who wants to page a UE 1 which it knows is associated with a UE 2, pages UE 1 in the same cell as UE 2 is associated with. For example, if the network knows that UE 2 is connected to cell A, the network would page UE 1 in cell A. Based on prior art the network may page UE 1 in the cell where UE 1 was last observed by the network, and if the UE does not respond to that paging the network may try to page the UE in a broader set of cells, (e.g., cells surrounding cell A, and if also that does not work the network may page the UE in a broader set of cells (e.g., all cells in the tracking area of cell A).

When it above says that the network pages UE 1 in the same where UE 2 is, it may mean the cell which serves as a Primary Cell (PCell) of UE 2.

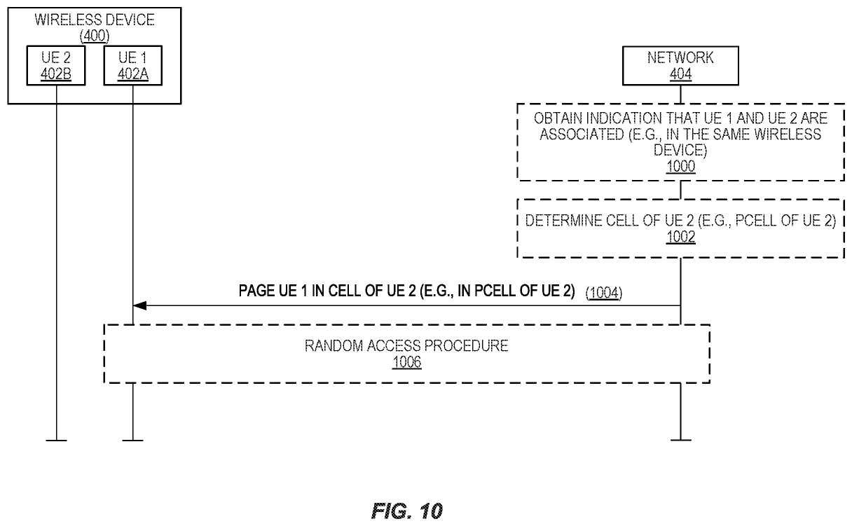

In this regard, FIG. 10 illustrates one example process in which the network node 404 (e.g., bases station 106 or a CN node (e.g., AMF)) pages UE 1 in a cell of UE 2 (e.g., PCell of UE 2). Optional steps are represented by dashed lines or dashed boxes. As illustrated, the network node 404 obtains an indication that UE 1 and UE 2 are associated (e.g., in the same wireless device), in accordance with any of the embodiments disclosed herein in which the network node 404 obtains such an indication (block 1000). The network node 404 determines a cell of UE 2 (e.g., PCell of UE 2), for example, when the network node 404 desires to page UE 1 (block 1002). The network node 404 then pages UE 1 in the cell of UE 2, e.g., by sending a paging message to UE 1 in the cell of UE 2 (block 1004). UE 1 then responds to the paging message by, e.g., performing a random access procedure in the cell of UE 2 (block 1006).

The network may combine information about UEs' mobility patterns and other observable characteristics to optimize management of the UEs (e.g., optimize RRM). One example is to populate the list of cell candidates for paging based on mobility of both UEs. This needs to consider special conditions, (e.g., frequencies priorities that may be assigned individually and differently), e.g. based on subscription information and/or usage of different slices configured on different frequencies.

This embodiment may need to be used with the feature described below where UE 1 camps on the same cell as UE 2.

In another embodiment, network node 404 indicates to UE 2 that UE 1 needs to wake up. When UE 2 receives such an indication, UE2 2 triggers UE 1 to change UE 2's state to wake up. Herein, wake up may mean that the UE starts monitoring one or more channels.

In a non-limiting example, UE 1 changes internal Discontinuous Reception (DRX) state based on an indication which was received by UE 2. Changing DRX state here may mean that the UE goes to Active Time from not being in Active Time. To achieve this, a timer may be started in UE 1 and UE 1 may consider itself to be in Active Time if that timer is running.

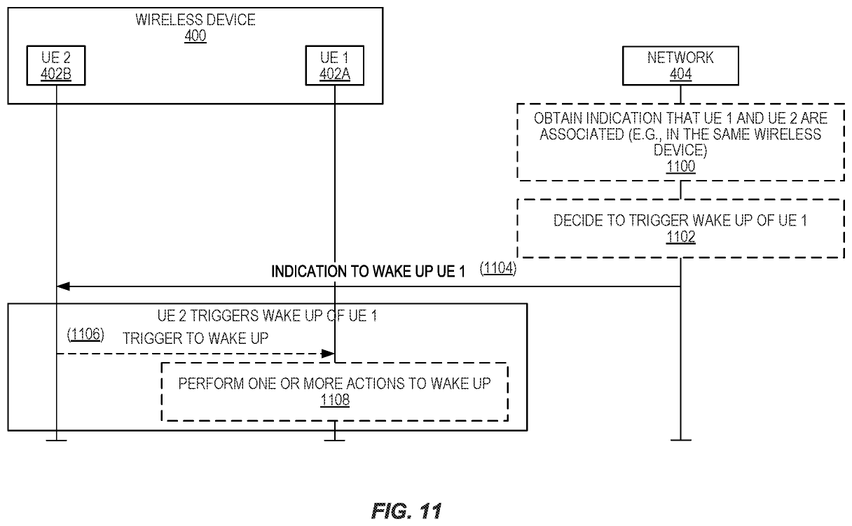

FIG. 11 illustrates one example of this embodiment. Optional steps are represented by dashed lines or dashed boxes. As illustrated, the network node 404 (e.g., base station 106 or core network node) obtains an indication that UE 1 and UE 2 are associated (e.g., in the same wireless device), in accordance with any of the embodiments disclosed herein in which the network node 404 obtains such an indication (block 1100). The network node 404 decides to wake up UE 1 (block 1102) and sends, to UE 2, an indication to wake up UE 1 (block 1104). In response, UE 2 triggers wakeup of UE 1. For example, UE 2 sends, to UE 1, a trigger to wake up (e.g., via one or more higher layers) (block 1106). In response, UE 1 performs one or more actions to wake up (e.g., starts monitoring one or more downlink channels, such as PDCCH) (block 1108).

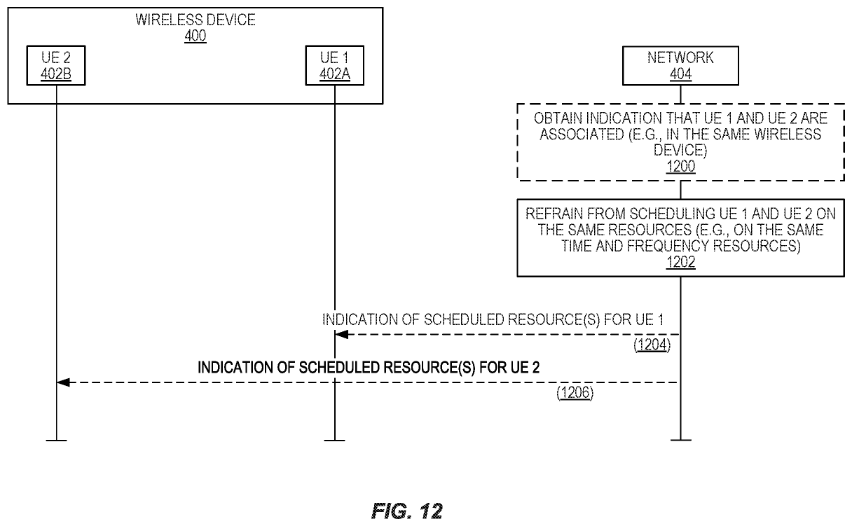

As shown in FIG. 12, the network node 404 refrains from scheduling UE 1 and UE 2 on the same resources (block 1202). This has the benefit that the wireless device 400 would not be requested to transmit with UE 1 and UE 2 at the same time. Or, for downlink, that UE 1 does not have to receive using UE 1 and UE 2 at the same time.

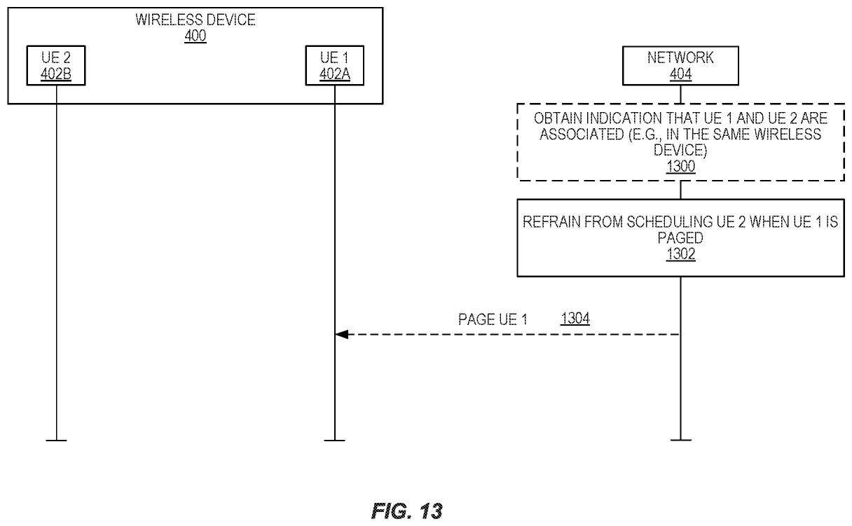

As shown in FIG. 13, UE is not scheduled (block 1302) when UE 1 is paged (block 1304).

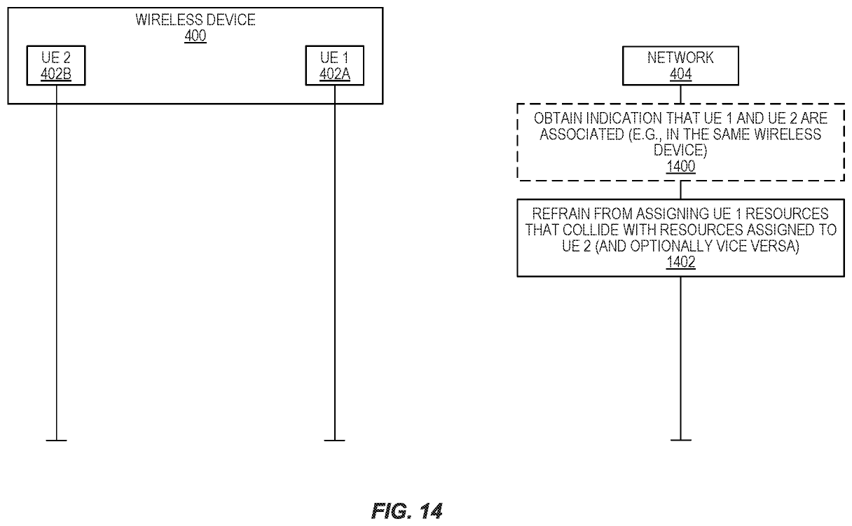

As shown in FIG. 14, the network node 404 avoids that the first UE gets assigned resources (e.g., SRS transmissions) that collide with resources which the second UE is assigned with (block 1402).

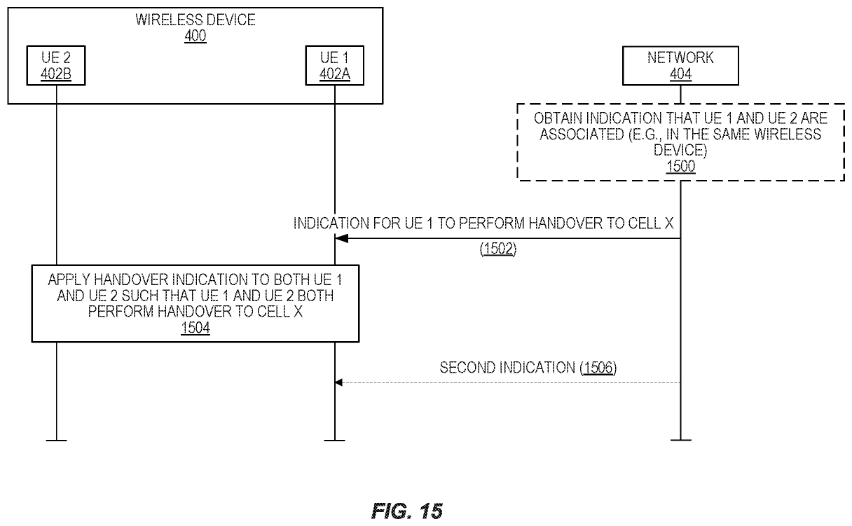

As shown in FIG. 15, the wireless device 400 receives a mobility command (e.g., handover command) for UE 1 (block 1502) and applies to UE 1 and UE 2. For example, if UE 1 is indicated to do a handover to cell X, the wireless device 400 performs a handover to cell X both for UE 1 and UE 2 (block 1504).

The network node 404 may indicate to a UE whether a handover command is applicable to another UE too (e.g., indicate to UE 1 that a handover command for that UE is applicable to another UE 2 as well) (block 1506). This indication may be sent in the handover command itself. Or the UE may be configured to apply this behavior in general, until further notice, etc.

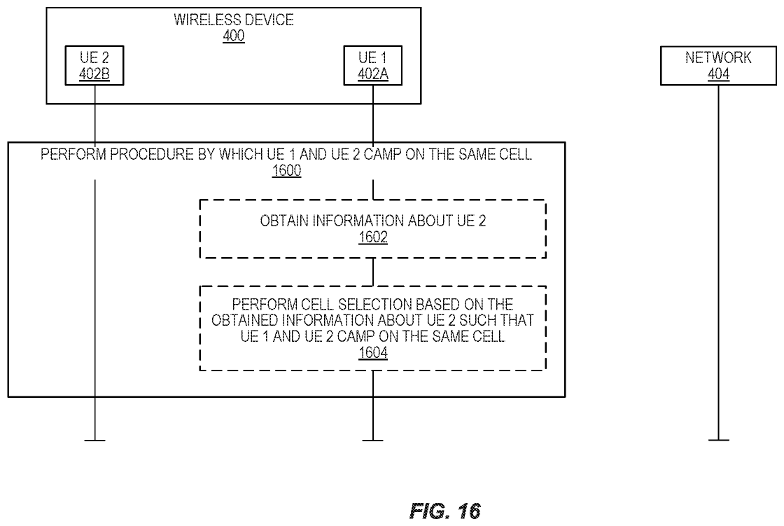

As shown in FIG. 16, a first and a second UE (UE 1 and UE 2) within a wireless device camp on the same cell (block 1600). This may be implemented by a procedure in UE 1 that performs cell (re)selection based on information about UE 2 (block 1604). For example, when (e.g., IDLE or INACTIVE in NR), UE 1 may select a cell which UE 2 has selected. UE 1 and UE 2 would then end up selecting the same cell to camp on. Alternatively, there may be an entity within the wireless device 400 which performs cell (re)selection for both UE 1 and UE 2 (rather than, as described above, UE 1 performing cell reselection based on information about UE 2).

In case UE 2 is in connected mode while UE 1 is in a mode where cell (re)selection is performed, UE 1 may select the cell which UE 2 is connected to. In case UE 2 are connected to multiple cells (e.g., in carrier aggregation or multi-/dual-connectivity), UE 1 may select one of the cells which UE 2 is connected to. UE 1 may select the cell that is the PCell for UE 2.

In one embodiment, the network node 404 may indicate to UE 2 which cell UE 1 should select during cell (re)selection. This may be beneficial if UE 2 is in connected mode and uses a cell, which for some reason is not suitable/optimal for UE 1 to camp on.

The network node 404 may control whether UE 1 should select the same cell as (or one of the cells which) UE 2 is associated with by sending an indication to the wireless device 400. This indication may be sent to UE 2 and UE 2 would trigger UE 1 to apply the behavior where it selects the same cell as UE 2 is associated with. Another approach is that the network indicates that this behavior should be applied for UEs by an indication in system information. If the cell if UE 2 is indicating such an indication, UE 2 would then indicate to UE 1 to apply this behavior. Another approach is that the network indicates directly to UE 1 to apply this behavior which may be done while the UE is in connected mode, or it may be indicated in a message used to indicate to UE 1 to enter a mode where cell (re)selection is applied such as in a message moving the UE to IDLE mode or to INACTIVE state.

In one embodiment UE 1 shares measurements with UE 2. This means that measurement results which are done by the device for UE 1 are considered also by UE 2. For example, if both UE 1 and UE 2 are measuring neighbor cells to perform cell reselection, they may camp on the same cell and hence if measurements are done for both UEs jointly, it can be avoided that measurements are performed for UE 1 and UE 2 separately which can save power.

In another example, the wireless device 400 may perform measurements for the purpose of reporting them to the network node 404. In case UE 1 and UE 2 are within the same wireless device, only one of the UEs may perform the measurements (or seen in another way, the wireless device are only performed once and the results are shared between the UEs within the wireless device). Note that reporting may be configured differently for the different UEs within the wireless device. For example, there may be different time to trigger criteria for UE 1 and UE 2 based on configuration from the network for these two different devices.

In one embodiment, the report of the measurements may be sent only by one UE and can be indicated to be applicable also for another UE. For example, if both UE 1 and UE 2 are configured to perform measurements on a certain frequency or of a certain cell, the measurement report may be sent by UE 1 but UE 2 refrains from sending a measurement report. This has the benefit that duplicate information is not sent by the wireless device.

In some embodiments, UE 1 and UE 2 are not allowed to be connected to the same cell, for example in a Non-Public Network (NPN).

The purpose of NPN is to create a network used for non-public purposes. Accordingly, U1 and UE2 would have different subscriptions and credentials. The NPN scenario may consist of shared networks. In scenario of integrated NPN, the UEs could have subscriptions with different PLMNs.

The other scenario is with non-integrated NPN. There could be shared cells, and each UE would register with its network and camp on shared cell. Otherwise cells may be dedicated, UEs would camp on different cells, and this could be similar to the scenario with different prioritized frequencies. It looks as if all written above would be applicable here as well.

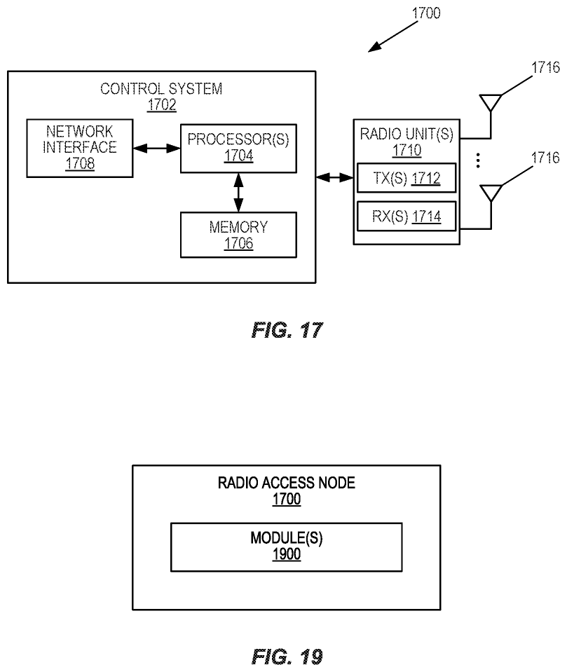

FIG. 17 is a schematic block diagram of a network node 1700 according to some embodiments of the present disclosure. The network node 1700 may be, for example, a radio access node (e.g., base station 102 or 106) or a core network node (e.g., a network node implementing a core network function such as, e.g., an AMF). As illustrated, the network node 1700 includes a control system 1702 that includes one or more processors 1704 (e.g., Central Processing Units (CPUs), Application Specific Integrated Circuits (ASICs), Field Programmable Gate Arrays (FPGAs), and/or the like), memory 1706, and a network interface 1708. The one or more processors 1704 are also referred to herein as processing circuitry. In addition, if the network node 1700 is a radio access node, the network node 1700 includes one or more radio units 1710 that each includes one or more transmitters 1712 and one or more receivers 1714 coupled to one or more antennas 1716. The radio units 1710 may be referred to or be part of radio interface circuitry. In some embodiments, the radio unit(s) 1710 is external to the control system 1702 and connected to the control system 1702 via, e.g., a wired connection (e.g., an optical cable). However, in some other embodiments, the radio unit(s) 1710 and potentially the antenna(s) 1716 are integrated together with the control system 1702. The one or more processors 1704 operate to provide one or more functions of the network node 1700 as described herein. In some embodiments, the function(s) are implemented in software that is stored, e.g., in the memory 1706 and executed by the one or more processors 1704.

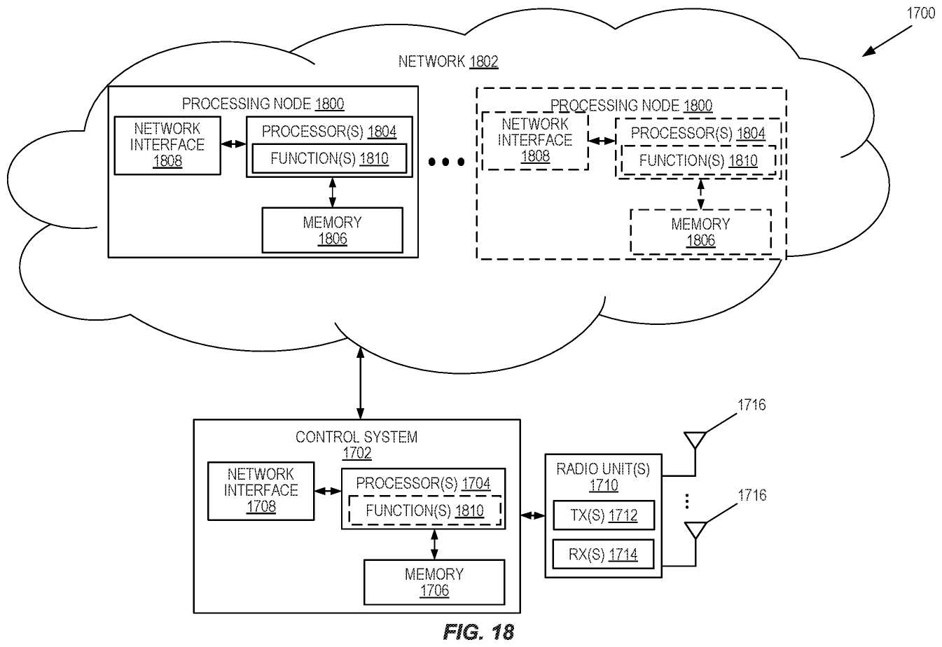

FIG. 18 is a schematic block diagram that illustrates a virtualized embodiment of the network node 1700 according to some embodiments of the present disclosure. This discussion is equally applicable to other types of network nodes. As used herein, a “virtualized” network node is an implementation of the network node 1700 in which at least a portion of the functionality of the network node 1700 is implemented as a virtual component(s) (e.g., via a virtual machine(s) executing on a physical processing node(s) in a network(s)). As illustrated, in this example, the network node 1700 includes one or more processing nodes 1800 coupled to or included as part of a network(s) 1802. Each processing node 1800 includes one or more processors 1804 (e.g., CPUs, ASICs, FPGAs, and/or the like), memory 1806, and a network interface 1808. In addition, if the network node 1700 is a radio access node, the network node 1700 may further include the control system 1702 and/or the one or more radio units 1710, as described above.

In this example, functions 1810 of the network node 1700 described herein are implemented at the one or more processing nodes 1800 or distributed across the control system 1702 and the one or more processing nodes 1800 in any desired manner. In some particular embodiments, some or all of the functions 1810 of the network node 1700 described herein are implemented as virtual components executed by one or more virtual machines implemented in a virtual environment(s) hosted by the processing node(s) 1800.

In some embodiments, a computer program including instructions which, when executed by at least one processor, causes the at least one processor to carry out the functionality of network node 1700 or a node (e.g., a processing node 1800) implementing one or more of the functions 1810 of the network node 1700 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 19 is a schematic block diagram of the network node 1700 according to some other embodiments of the present disclosure. The network node 1700 includes one or more modules 1900, each of which is implemented in software. The module(s) 1900 provide the functionality of the network node 1700 described herein. This discussion is equally applicable to the processing node 1800 of FIG. 18 where the modules 1900 may be implemented at one of the processing nodes 1800 or distributed across multiple processing nodes 1800 and/or distributed across the processing node(s) 1800 and the control system 1702.

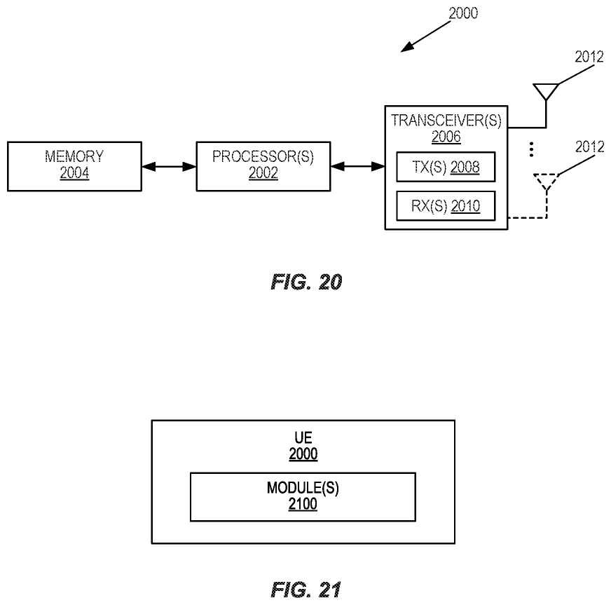

FIG. 20 is a schematic block diagram of a UE 2000 according to some embodiments of the present disclosure. Notably, the UE 2000 may be a wireless device that is seen has having multiple UEs (e.g., a dual-SIM or multi-SIM UE). Alternatively, the UE 2000 may be, e.g., UE 1 or UE 2 described in the embodiments above. As illustrated, the UE 2000 includes one or more processors 2002 (e.g., CPUs, ASICs, FPGAs, and/or the like), memory 2004, and one or more transceivers 2006 each including one or more transmitters 2008 and one or more receivers 2010 coupled to one or more antennas 2012. The transceiver(s) 2006 includes radio-front end circuitry connected to the antenna(s) 2012 that is configured to condition signals communicated between the antenna(s) 2012 and the processor(s) 2002, as will be appreciated by one of ordinary skill in the art. The processors 2002 are also referred to herein as processing circuitry. The transceivers 2006 are also referred to herein as radio circuitry. In some embodiments, the functionality of the UE 2000 described above may be fully or partially implemented in software that is, e.g., stored in the memory 2004 and executed by the processor(s) 2002. Note that the UE 2000 may include additional components not illustrated in FIG. 20 such as, e.g., one or more user interface components (e.g., an input/output interface including a display, buttons, a touch screen, a microphone, a speaker(s), and/or the like and/or any other components for allowing input of information into the UE 2000 and/or allowing output of information from the UE 2000), a power supply (e.g., a battery and associated power circuitry), etc.

In some embodiments, a computer program including instructions which, when executed by at least one processor, causes the at least one processor to carry out the functionality of the UE 2000 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 21 is a schematic block diagram of the UE 2000 according to some other embodiments of the present disclosure. The UE 2000 includes one or more modules 2100, each of which is implemented in software. The module(s) 2100 provide the functionality of the UE 2000 described herein.

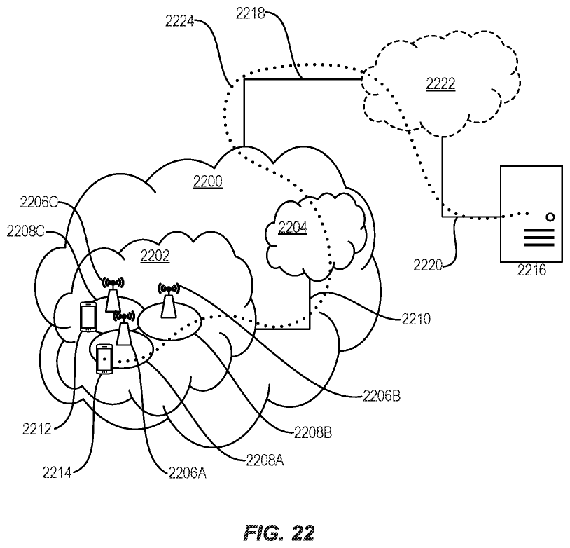

With reference to FIG. 22, in accordance with an embodiment, a communication system includes a telecommunication network 2200, such as a 3GPP-type cellular network, which comprises an access network 2202, such as a RAN, and a core network 2204. The access network 2202 comprises a plurality of base stations 2206A, 2206B, 2206C, such as Node Bs, eNBs, gNBs, or other types of wireless Access Points (APs), each defining a corresponding coverage area 2208A, 2208B, 2208C. Each base station 2206A, 2206B, 2206C is connectable to the core network 2204 over a wired or wireless connection 2210. A first UE 2212 located in coverage area 2208C is configured to wirelessly connect to, or be paged by, the corresponding base station 2206C. A second UE 2214 in coverage area 2208A is wirelessly connectable to the corresponding base station 2206A. While a plurality of UEs 2212, 2214 are illustrated in this example, the disclosed embodiments are equally applicable to a situation where a sole UE is in the coverage area or where a sole UE is connecting to the corresponding base station 2206.

The telecommunication network 2200 is itself connected to a host computer 2216, which may be embodied in the hardware and/or software of a standalone server, a cloud-implemented server, a distributed server, or as processing resources in a server farm. The host computer 2216 may be under the ownership or control of a service provider, or may be operated by the service provider or on behalf of the service provider. Connections 2218 and 2220 between the telecommunication network 2200 and the host computer 2216 may extend directly from the core network 2204 to the host computer 2216 or may go via an optional intermediate network 2222. The intermediate network 2222 may be one of, or a combination of more than one of, a public, private, or hosted network; the intermediate network 2222, if any, may be a backbone network or the Internet; in particular, the intermediate network 2222 may comprise two or more sub-networks (not shown).

The communication system of FIG. 22 as a whole enables connectivity between the connected UEs 2212, 2214 and the host computer 2216. The connectivity may be described as an Over-the-Top (OTT) connection 2224. The host computer 2216 and the connected UEs 2212, 2214 are configured to communicate data and/or signaling via the OTT connection 2224, using the access network 2202, the core network 2204, any intermediate network 2222, and possible further infrastructure (not shown) as intermediaries. The OTT connection 2224 may be transparent in the sense that the participating communication devices through which the OTT connection 2224 passes are unaware of routing of uplink and downlink communications. For example, the base station 2206 may not or need not be informed about the past routing of an incoming downlink communication with data originating from the host computer 2216 to be forwarded (e.g., handed over) to a connected UE 2212. Similarly, the base station 2206 need not be aware of the future routing of an outgoing uplink communication originating from the UE 2212 towards the host computer 2216.

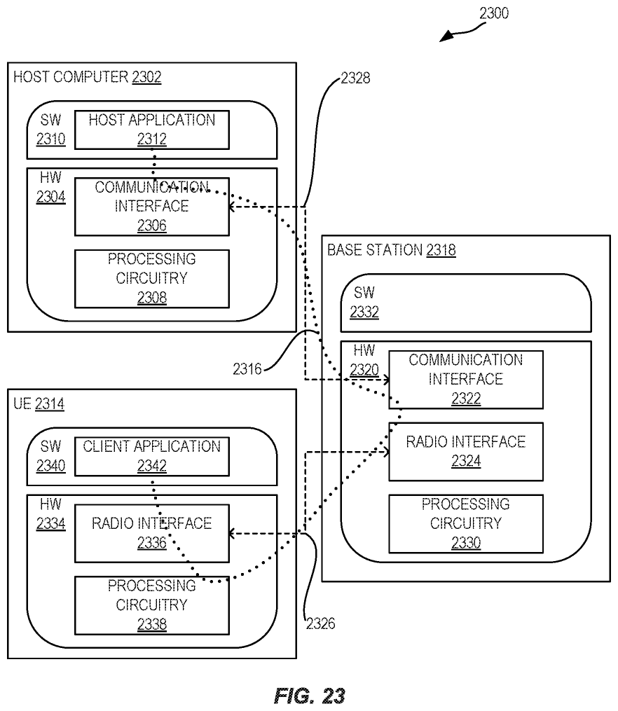

Example implementations, in accordance with an embodiment, of the UE, base station, and host computer discussed in the preceding paragraphs will now be described with reference to FIG. 23. In a communication system 2300, a host computer 2302 comprises hardware 2304 including a communication interface 2306 configured to set up and maintain a wired or wireless connection with an interface of a different communication device of the communication system 2300. The host computer 2302 further comprises processing circuitry 2308, which may have storage and/or processing capabilities. In particular, the processing circuitry 2308 may comprise one or more programmable processors, ASICs, FPGAs, or combinations of these (not shown) adapted to execute instructions. The host computer 2302 further comprises software 2310, which is stored in or accessible by the host computer 2302 and executable by the processing circuitry 2308. The software 2310 includes a host application 2312. The host application 2312 may be operable to provide a service to a remote user, such as a UE 2314 connecting via an OTT connection 2316 terminating at the UE 2314 and the host computer 2302. In providing the service to the remote user, the host application 2312 may provide user data which is transmitted using the OTT connection 2316.

The communication system 2300 further includes a base station 2318 provided in a telecommunication system and comprising hardware 2320 enabling it to communicate with the host computer 2302 and with the UE 2314. The hardware 2320 may include a communication interface 2322 for setting up and maintaining a wired or wireless connection with an interface of a different communication device of the communication system 2300, as well as a radio interface 2324 for setting up and maintaining at least a wireless connection 2326 with the UE 2314 located in a coverage area (not shown in FIG. 23) served by the base station 2318. The communication interface 2322 may be configured to facilitate a connection 2328 to the host computer 2302. The connection 2328 may be direct or it may pass through a core network (not shown in FIG. 23) of the telecommunication system and/or through one or more intermediate networks outside the telecommunication system. In the embodiment shown, the hardware 2320 of the base station 2318 further includes processing circuitry 2330, which may comprise one or more programmable processors, ASICs, FPGAs, or combinations of these (not shown) adapted to execute instructions. The base station 2318 further has software 2332 stored internally or accessible via an external connection.

The communication system 2300 further includes the UE 2314 already referred to. The UE's 2314 hardware 2334 may include a radio interface 2336 configured to set up and maintain a wireless connection 2326 with a base station serving a coverage area in which the UE 2314 is currently located. The hardware 2334 of the UE 2314 further includes processing circuitry 2338, which may comprise one or more programmable processors, ASICs, FPGAs, or combinations of these (not shown) adapted to execute instructions. The UE 2314 further comprises software 2340, which is stored in or accessible by the UE 2314 and executable by the processing circuitry 2338. The software 2340 includes a client application 2342. The client application 2342 may be operable to provide a service to a human or non-human user via the UE 2314, with the support of the host computer 2302. In the host computer 2302, the executing host application 2312 may communicate with the executing client application 2342 via the OTT connection 2316 terminating at the UE 2314 and the host computer 2302. In providing the service to the user, the client application 2342 may receive request data from the host application 2312 and provide user data in response to the request data. The OTT connection 2316 may transfer both the request data and the user data. The client application 2342 may interact with the user to generate the user data that it provides.

It is noted that the host computer 2302, the base station 2318, and the UE 2314 illustrated in FIG. 23 may be similar or identical to the host computer 2016, one of the base stations 2206A, 2206B, 2206C, and one of the UEs 2212, 2214 of FIG. 22, respectively. This is to say, the inner workings of these entities may be as shown in FIG. 23 and independently, the surrounding network topology may be that of FIG. 20.

In FIG. 23, the OTT connection 2316 has been drawn abstractly to illustrate the communication between the host computer 2302 and the UE 2314 via the base station 2318 without explicit reference to any intermediary devices and the precise routing of messages via these devices. The network infrastructure may determine the routing, which may be configured to hide from the UE 2314 or from the service provider operating the host computer 2302, or both. While the OTT connection 2316 is active, the network infrastructure may further take decisions by which it dynamically changes the routing (e.g., on the basis of load balancing consideration or reconfiguration of the network).

The wireless connection 2326 between the UE 2314 and the base station 2318 is in accordance with the teachings of the embodiments described throughout this disclosure. One or more of the various embodiments improve the performance of OTT services provided to the UE 2314 using the OTT connection 2316, in which the wireless connection 2326 forms the last segment.

A measurement procedure may be provided for the purpose of monitoring data rate, latency, and other factors on which the one or more embodiments improve. There may further be an optional network functionality for reconfiguring the OTT connection 2316 between the host computer 2302 and the UE 2314, in response to variations in the measurement results. The measurement procedure and/or the network functionality for reconfiguring the OTT connection 2316 may be implemented in the software 2310 and the hardware 2304 of the host computer 2302 or in the software 2340 and the hardware 2334 of the UE 2314, or both. In some embodiments, sensors (not shown) may be deployed in or in association with communication devices through which the OTT connection 2316 passes; the sensors may participate in the measurement procedure by supplying values of the monitored quantities exemplified above, or supplying values of other physical quantities from which the software 2310, 2340 may compute or estimate the monitored quantities. The reconfiguring of the OTT connection 2316 may include message format, retransmission settings, preferred routing, etc.; the reconfiguring need not affect the base station 2318, and it may be unknown or imperceptible to the base station 2318. Such procedures and functionalities may be known and practiced in the art. In certain embodiments, measurements may involve proprietary UE signaling facilitating the host computer 2302's measurements of throughput, propagation times, latency, and the like. The measurements may be implemented in that the software 2310 and 2340 causes messages to be transmitted, in particular empty or ‘dummy’ messages, using the OTT connection 2316 while it monitors propagation times, errors, etc.

FIG. 24 is a flowchart illustrating a method implemented in a communication system, in accordance with one embodiment. The communication system includes a host computer, a base station, and a UE which may be those described with reference to FIGS. 22 and 23. For simplicity of the present disclosure, only drawing references to FIG. 24 will be included in this section. In step 2400, the host computer provides user data. In sub-step 2402 (which may be optional) of step 2400, the host computer provides the user data by executing a host application. In step 2404, the host computer initiates a transmission carrying the user data to the UE. In step 2406 (which may be optional), the base station transmits to the UE the user data which was carried in the transmission that the host computer initiated, in accordance with the teachings of the embodiments described throughout this disclosure. In step 2408 (which may also be optional), the UE executes a client application associated with the host application executed by the host computer.

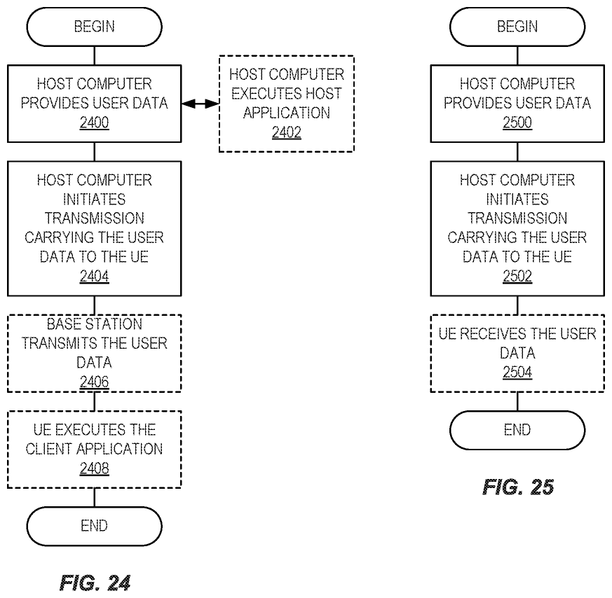

FIG. 25 is a flowchart illustrating a method implemented in a communication system, in accordance with one embodiment. The communication system includes a host computer, a base station, and a UE which may be those described with reference to FIGS. 22 and 23. For simplicity of the present disclosure, only drawing references to FIG. 25 will be included in this section. In step 2500 of the method, the host computer provides user data. In an optional sub-step (not shown) the host computer provides the user data by executing a host application. In step 2502, the host computer initiates a transmission carrying the user data to the UE. The transmission may pass via the base station, in accordance with the teachings of the embodiments described throughout this disclosure. In step 2504 (which may be optional), the UE receives the user data carried in the transmission.

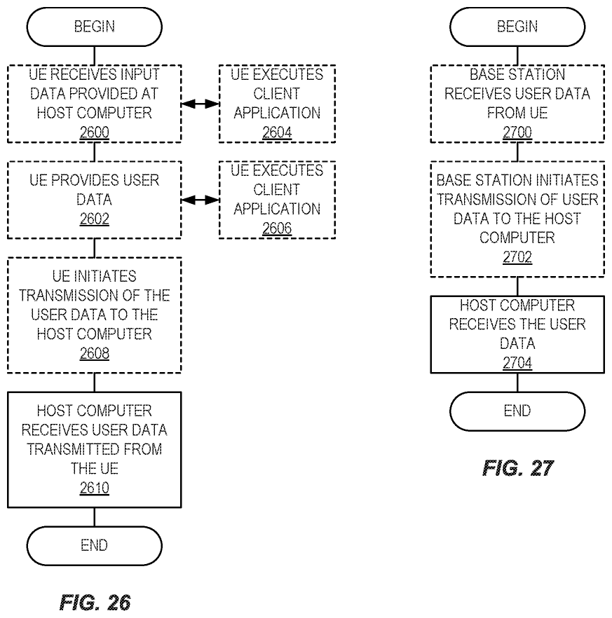

FIG. 26 is a flowchart illustrating a method implemented in a communication system, in accordance with one embodiment. The communication system includes a host computer, a base station, and a UE which may be those described with reference to FIGS. 22 and 23. For simplicity of the present disclosure, only drawing references to FIG. 26 will be included in this section. In step 2600 (which may be optional), the UE receives input data provided by the host computer. Additionally or alternatively, in step 2602, the UE provides user data. In sub-step 2604 (which may be optional) of step 2600, the UE provides the user data by executing a client application. In sub-step 2606 (which may be optional) of step 2602, the UE executes a client application which provides the user data in reaction to the received input data provided by the host computer. In providing the user data, the executed client application may further consider user input received from the user. Regardless of the specific manner in which the user data was provided, the UE initiates, in sub-step 2608 (which may be optional), transmission of the user data to the host computer. In step 2610 of the method, the host computer receives the user data transmitted from the UE, in accordance with the teachings of the embodiments described throughout this disclosure.

FIG. 27 is a flowchart illustrating a method implemented in a communication system, in accordance with one embodiment. The communication system includes a host computer, a base station, and a UE which may be those described with reference to FIGS. 22 and 23. For simplicity of the present disclosure, only drawing references to FIG. 27 will be included in this section. In step 2700 (which may be optional), in accordance with the teachings of the embodiments described throughout this disclosure, the base station receives user data from the UE. In step 2702 (which may be optional), the base station initiates transmission of the received user data to the host computer. In step 2704 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some exemplary embodiments of the present disclosure are as follows.

### Group A Embodiments

Embodiment 1: A method performed by a wireless device that is perceived, by a cellular communications system, as multiple UEs (UE 1, UE 2, and optionally one or more additional UEs), the method comprising sending, for the UE) to a network node, an indication that the UE) is associated with the UE 2.

Embodiment 2: The method of embodiment 1 wherein sending the indication comprises sending, for the UE 1 to the network node, UE capability information comprising the indication that the UE 1 is associated with the UE 2.

Embodiment 3: The method of embodiment 1 wherein sending the indication comprises sending the indication in response to a request from the network node.

Embodiment 4: The method of embodiment 1 wherein sending the indication comprises sending the indication to the network node in response to a triggering event.

Embodiment 5: The method of embodiment 1 wherein sending the indication comprises sending the indication to the network node during an access procedure.

Embodiment 6: The method of embodiment 1 wherein sending the indication comprises sending the indication to the network node in a security related message (e.g., SecurityModeComplete message).

Embodiment 7: The method of any one of embodiments 1 to 6 wherein the indication comprises an identity of the UE 2.

Embodiment 8: The method of embodiment 7 wherein the identity of the UE 2 comprises a C-RNTI of UE 2, an S-TMSI of UE 2, an I-RNTI of UE 2, a Resume ID of UE 2, a GUIT of UE 2, or a new identity of UE 2 for purposes of indicating the association between UE 2 and other UE(s).

Embodiment 9: A method performed by a wireless device that is perceived, by a cellular communications system, as multiple UEs (UE 1, UE 2, and optionally one or more additional UEs), the method comprising receiving a paging message for UE 1 in a cell of UE 2.

Embodiment 10: The method of embodiment 9 further comprising performing one or more actions in response to the paging message (e.g., performing a random access procedure in the cell of UE 2).

Embodiment 11: The method of embodiment 9 or 10 wherein the cell of UE 2 is a PCell of UE 2.

Embodiment 12: A method performed by a wireless device that is perceived, by a cellular communications system, as multiple UEs (UE 1, UE 2, and optionally one or more additional UEs), the method comprising receiving, for UE 2 from a network node, an indication to wake up UE 1 and upon receiving the indication to wake up UE 1, performing one or more actions to trigger wake up of UE 1.

Embodiment 13: A method performed by a wireless device that is perceived, by a cellular communications system, as multiple UEs (UE 1, UE 2, and optionally one or more additional UEs), the method comprising receiving, for UE 1 from a network node, an indication for UE 1 to handover to a particular cell and performing one or more actions such that both UE 1 and UE 2 handover to the particular cell, in response to receiving the indication for UE 1 to handover to the particular cell.

Embodiment 14: The method of embodiment 13 further comprising receiving a second indication that indicates whether the indication for UE 1 to handover to the particular cell is also applicable to UE 2.

Embodiment 15: A method performed by a wireless device that is perceived, by a cellular communications system, as multiple UEs (UE 1, UE 2, and optionally one or more additional UEs), the method comprising performing a procedure by which UE 1 and UE 2 select the same cell to camp on.

Embodiment 16: The method of embodiment 15 wherein performing the procedure comprises obtaining, at the UE 1, information about the UE 2 and performing cell selection at the UE 2 based on the information about the UE 2 such that the UE 1 and the UE 2 camp on the same cell.

Embodiment 17: The method of embodiment 15 wherein performing the procedure comprises performing cell selection for both the UE 1 and the UE 2 at a single entity within the wireless device such that the UE 1 and the UE 2 camp on the same cell.

Embodiment 18: A method performed by a wireless device that is perceived, by a cellular communications system, as multiple UEs (UE 1, UE 2, and optionally one or more additional UEs), the method comprising performing measurements for the UE 1 and sharing the measurements with the UE 2.

Embodiment 19: The method of any of the previous embodiments, further comprising providing user data and forwarding the user data to a host computer via the transmission to the base station.

### Group B Embodiments

Embodiment 20: A method performed by a base station comprising receiving an indication that a first UE (UE 1) and a second UE (UE 2) are associated and performing one or more actions using the indication.

Embodiment 21: The method of embodiment 20 wherein the one or more actions comprise providing the indication to another network node.

Embodiment 22: The method of embodiment 20 or 21 wherein the one or more actions comprise paging UE 1 in a cell of UE 2 (e.g., a PCell of UE 2).

Embodiment 23: The method of any one of embodiments 20 to 22 wherein the one or more actions comprise sending an indication to UE 2 to wake up UE 1.

Embodiment 24: The method of any one of embodiments 20 to 23 wherein the one or more actions comprise refraining from scheduling UE 1 and UE 2 on the same resources (e.g., on the same time and frequency resources).

Embodiment 25: The method of any one of embodiments 20 to 24 wherein the one or more actions comprise scheduling UE 1 and UE 2 on different resources (e.g., on different time and frequency resources).

Embodiment 26: The method of any one of embodiments 20 to 25 wherein the one or more actions comprise refraining from scheduling UE 2 when UE 1 is paged.

Embodiment 27: The method of any one of embodiments 20 to 26 wherein the one or more actions comprise sending, to UE 1, an indication for UE 1 to handover to a particular cell and a second indication that the indication for UE 1 to handover to the particular cell is also applicable to UE 2.

Embodiment 28: The method of any one of embodiments 20 to 27 wherein receiving the indication that the first UE (UE 1) and the second UE (UE 2) are associated comprises receiving the indication that the first UE (UE 1) and the second UE (UE 2) are associated from the first UE (UE 1).

Embodiment 29: The method of embodiment 28 wherein the indication comprises an identity of the UE 2.

Embodiment 30: The method of embodiment 29 wherein the identity of the UE 2 comprises a C-RNTI of UE 2, an S-TMSI of UE 2, an I-RNTI of UE 2, a Resume ID of UE 2, a GUIT of UE 2, or a new identity of UE 2 for purposes of indicating the association between UE 2 and other UE(s).

Embodiment 31: The method of any one of embodiments 20 to 27 wherein receiving the indication that the first UE (UE 1) and the second UE (UE 2) are associated comprises receiving the indication that the first UE (UE 1) and the second UE (UE 2) are associated from the second UE (UE 2).

Embodiment 32: The method of embodiment 31 wherein the indication comprises an identity of the UE 1.

Embodiment 33: The method of embodiment 32 wherein the identity of the UE 1 comprises a C-RNTI of UE 1, an S-TMSI of UE 1, an I-RNTI of UE 1, a Resume ID of UE 1, a GUIT of UE 1, or a new identity of UE 1 for purposes of indicating the association between UE 1 and other UE(s).

Embodiment 34: The method of any one of embodiments 20 to 27 wherein receiving the indication that the first UE (UE 1) and the second UE (UE 2) are associated comprises receiving the indication that the first UE (UE 1) and the second UE (UE 2) are associated from another network node (e.g., a core network node).

Embodiment 35: The method of any of the previous embodiments, further comprising obtaining user data and forwarding the user data to a host computer or a wireless device.

### Group C Embodiments

Embodiment 36: A method performed by core network node, comprising providing, to a radio access node, an indication that a first UE (UE 1) and a second UE (UE 2) are associated.

Embodiment 37: The method of embodiment 36, further comprising obtaining information that indicates that the first UE (UE 1) and the second UE (UE 2) are associated (e.g., the indication that the first UE (UE 1) and the second UE (UE 2) are associated) from another network node (e.g., a UDM or an AMF).

### Group D Embodiments

Embodiment 38: A wireless device comprising processing circuitry configured to perform any of the steps of any of the Group A embodiments and power supply circuitry configured to supply power to the wireless device.

Embodiment 39: A base station comprising processing circuitry configured to perform any of the steps of any of the Group B embodiments and power supply circuitry configured to supply power to the base station.

Embodiment 40: A User Equipment, UE, comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and—
a battery connected to the processing circuitry and configured to supply power to the UE.

Embodiment 41: A communication system including a host computer comprising:
processing circuitry configured to provide user data; and
a communication interface configured to forward the user data to a cellular network for transmission to a User Equipment, UE;
wherein the cellular network comprises a base station having a radio interface and processing circuitry, the base station's processing circuitry configured to perform any of the steps of any of the Group B embodiments.

Embodiment 42: The communication system of the previous embodiment further including the base station.

Embodiment 43: The communication system of the previous 2 embodiments, further including the UE, wherein the UE is configured to communicate with the base station.

Embodiment 44: The communication system of the previous 3 embodiments, wherein:
the processing circuitry of the host computer is configured to execute a host application, thereby providing the user data; and
the UE comprises processing circuitry configured to execute a client application associated with the host application.

Embodiment 45: A method implemented in a communication system including a host computer, a base station, and a User Equipment, UE, the method comprising:
at the host computer, providing user data; and
at the host computer, initiating a transmission carrying the user data to the UE via a cellular network comprising the base station, wherein the base station performs any of the steps of any of the Group B embodiments.

Embodiment 46: The method of the previous embodiment, further comprising, at the base station, transmitting the user data.

Embodiment 47: The method of the previous 2 embodiments, wherein the user data is provided at the host computer by executing a host application, the method further comprising, at the UE, executing a client application associated with the host application.

Embodiment 48: A User Equipment, UE, configured to communicate with a base station, the UE comprising a radio interface and processing circuitry configured to perform the method of the previous 3 embodiments.

Embodiment 49: A communication system including a host computer comprising:
processing circuitry configured to provide user data; and
a communication interface configured to forward user data to a cellular network for transmission to a User Equipment, UE;
wherein the UE comprises a radio interface and processing circuitry, the UE's components configured to perform any of the steps of any of the Group A embodiments.

Embodiment 50: The communication system of the previous embodiment, wherein the cellular network further includes a base station configured to communicate with the UE.

Embodiment 51: The communication system of the previous 2 embodiments, wherein:
the processing circuitry of the host computer is configured to execute a host application, thereby providing the user data; and
the UE's processing circuitry is configured to execute a client application associated with the host application.

Embodiment 52: A method implemented in a communication system including a host computer, a base station, and a User Equipment, UE, the method comprising:
at the host computer, providing user data; and
at the host computer, initiating a transmission carrying the user data to the UE via a cellular network comprising the base station, wherein the UE performs any of the steps of any of the Group A embodiments.

Embodiment 53: The method of the previous embodiment, further comprising at the UE, receiving the user data from the base station.

Embodiment 54: A communication system including a host computer comprising:
communication interface configured to receive user data originating from a transmission from a User Equipment, UE, to a base station;
wherein the UE comprises a radio interface and processing circuitry, the UE's processing circuitry configured to perform any of the steps of any of the Group A embodiments.

Embodiment 55: The communication system of the previous embodiment, further including the UE.

Embodiment 56: The communication system of the previous 2 embodiments, further including the base station, wherein the base station comprises a radio interface configured to communicate with the UE and a communication interface configured to forward to the host computer the user data carried by a transmission from the UE to the base station.

Embodiment 57: The communication system of the previous 3 embodiments, wherein:
the processing circuitry of the host computer is configured to execute a host application; and
the UE's processing circuitry is configured to execute a client application associated with the host application, thereby providing the user data.

Embodiment 58: The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

Embodiment 59: A method implemented in a communication system including a host computer, a base station, and a User Equipment, UE, the method comprising at the host computer, receiving user data transmitted to the base station from the UE, wherein the UE performs any of the steps of any of the Group A embodiments.

Embodiment 60: The method of the previous embodiment, further comprising, at the UE, providing the user data to the base station.

Embodiment 61: The method of the previous 2 embodiments, further comprising:
at the UE, executing a client application, thereby providing the user data to be transmitted; and
at the host computer, executing a host application associated with the client application.

Embodiment 62: The method of the previous 3 embodiments, further comprising:
at the UE, executing a client application; and
at the UE, receiving input data to the client application, the input data being provided at the host computer by executing a host application associated with the client application;
wherein the user data to be transmitted is provided by the client application in response to the input data.

Embodiment 63: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 64: The communication system of the previous embodiment further including the base station.

Embodiment 65: The communication system of the previous 2 embodiments, further including the UE, wherein the UE is configured to communicate with the base station.

Embodiment 66: The communication system of the previous 3 embodiments, wherein:
the processing circuitry of the host computer is configured to execute a host application; and
the UE is configured to execute a client application associated with the host application, thereby providing the user data to be received by the host computer.

Embodiment 67: A method implemented in a communication system including a host computer, a base station, and a User Equipment, UE, the method comprising at the host computer, receiving, from the base station, user data originating from a transmission which the base station has received from the UE, wherein the UE performs any of the steps of any of the Group A embodiments.

Embodiment 68: The method of the previous embodiment, further comprising at the base station, receiving the user data from the UE.

Embodiment 69: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CN Core Network
CPU Central Processing Unit
C-RNTI Cell Radio Network Temporary Identifier
DN Data Network
DRX Discontinuous Reception
DSP Digital Signal Processor
eNB Enhanced or Evolved Node B
EPC Evolved Packet Core
EPS Evolved Packet System
E-UTRA Evolved Universal Terrestrial Radio Access
FPGA Field Programmable Gate Array
gNB New Radio Base Station
gNB-DU New Radio Base Station Distributed Unit
GUAMI Globally Unique AMF Identification
GUTI Global Unique Temporary Identifier
HSS Home Subscriber Server
IMEI International Mobile Equipment Identity
IMSI International Mobile Subscriber Identity
IP Internet Protocol
I-RNTI Inactive Radio Network Temporary Identifier
LTE Long Term Evolution
MME Mobility Management Entity
MTC Machine Type Communication
NAS Non-Access Stratum
NEF Network Exposure Function
NF Network Function
NGAP New Generation Application Protocol
NPN Non-Public Network
NR New Radio
NRF Network Function Repository Function
NSSF Network Slice Selection Function
OTT Over-the-Top
PCELL Primary Cell
PCF Policy Control Function
P-GW Packet Data Network Gateway
QoS Quality of Service
RAM Random Access Memory
RAN Radio Access Network
ROM Read Only Memory
RRC Radio Resource Control
RRH Remote Radio Head
RTT Round Trip Time
SCEF Service Capability Exposure Function
SIM Subscriber Identity Modules
SMF Session Management Function
S-TMSI Serving Temporary Mobile Subscriber Identity
SUPI Subscription Permanent Identifiers
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a wireless device for indicating and operating multiple User Equipment, UEs, comprising:
sending an indication to a network node to indicate a relation between a first UE and a second UE, both comprised in the wireless device, wherein the relation comprises an identity that defines an association between the first UE and the second UE in the wireless device; and
performing one or more actions based on the indicated relation.

2. The method of claim 1, further comprising detecting a triggering event for indicating the relation between the first UE and the second UE prior to sending the indication to the network node.

3. The method of claim 2, wherein the triggering event comprises one or more of:
reception of a request from the network node;
activation of a new Subscriber Identification Module, SIM, in the wireless device;
establishment of a network connection by the wireless device; and
performance of a network access procedure by the wireless device.

4. The method of claim 1, wherein sending the indication comprises sending, from the first UE to the network node or from the second UE to the network node, a UE capability information comprising the indication that the first UE is associated with the second UE.

5. The method of claim 1, wherein sending the indication comprises sending the indication during a Radio Resource Control, RRC, connection establishment procedure.

6. The method of claim 1, wherein sending the indication comprises securing the indication by means of one or more of:
encrypting the indication;
sending the indication after enabling security with the network node; and
sending the indication in a message for enabling the security with the network node.

7. The method of claim 1, wherein performing one or more actions based on the indicated relation comprises, at the first UE:
receiving a paging message in a cell of the second UE; and
performing a random access procedure in response to receiving the paging message.

8. The method of claim 7, wherein the cell of the second UE is a Primary Cell, PCell, of the second UE.

9. The method of claim 1, wherein performing one or more actions comprises, at the second UE:
receiving an indication from the network node to wake up the first UE; and
triggering the first UE to wake up upon receiving the indication to wake up the first UE.

10. The method of claim 9, wherein performing one or more actions further comprises performing one or more actions at the first UE to wake up.

11. The method of claim 1, wherein performing one or more actions comprises, at the first UE:
receiving a handover indication from the network node to hand over to a particular cell; and
applying the handover indication to both the first UE and the second UE such that the first UE and the second UE both hand over to the particular cell.

12. The method of claim 11, further comprising receiving, at the first UE, a second indication that indicates whether the handover indication is applicable to the second UE.

13. The method of claim 1, wherein performing one or more actions comprises performing a procedure whereby the first UE and the second UE select a same cell to camp on.

14. The method of claim 13, wherein performing the procedure comprises, at the first UE:
obtaining information about the second UE; and
performing cell selection based on the information about the second UE.

15. The method of claim 1, wherein performing one or more actions comprises, at the first UE:
performing a measurement at the first UE; and
sharing the measurement with the second UE.

16. A method performed by a network node for a cellular communications system, comprising:
receiving an indication that indicates a relation between a first User Equipment, UE, and a second UE both comprised in a wireless device, wherein the relation comprises an identity that defines an association between the first UE and the second UE in the wireless device; and
performing one or more actions based on the indicated relation.

17. The method of claim 16, wherein performing one or more actions comprises providing the indication to another network node.

18. The method of claim 16, wherein performing one or more actions comprises sending a paging message to the first UE in a cell of the second UE.

19-31. (canceled)

32. A wireless device, comprising:
processing circuitry configured to:
send an indication to a network node to indicate a relation between a first User Equipment, UE, and a second UE, both comprised in the wireless device, wherein the relation comprises an identity that defines an association between the first UE and the second UE in the wireless device; and
perform one or more actions based on the indicated relation; and
power supply circuitry configured to supply power to the wireless device.

33. A network node, comprising a control system configured to cause the network node to:
receive an indication that indicates a relation between a first User Equipment, UE, and a second UE both comprised in a wireless device, wherein the relation comprises an identity that defines an association between the first UE and the second UE in the wireless device; and
perform one or more actions based on the indicated relation.

34. (canceled)

35. (canceled)
